(19) United States
(12) Patent Application Publication
(10) Pub. No.: US 2025/0015530 A1
(43) Pub. Date: Jan. 9, 2025

(54) PLUG CONNECTOR, HOLDING ELEMENT, AND SET COMPRISING A PLUG CONNECTOR AND A HOLDING ELEMENT

(71) Applicant: WAGO Verwaltungsgesellschaft mbH, Minden (DE)

(72) Inventors: Marcel PAHL, Schloss Halte-Stukenbrock (DE); Rudolf MASTEL, Minden (DE); Philipp OBER-WOERDER, Minden (DE)

(73) Assignee: WAGO Verwaltungsgesellschaft mbH, Minden (DE)

(21) Appl. No.: 18/884,992

(22) Filed: Sep. 13, 2024

Related U.S. Application Data
(63) Continuation of application No. PCT/EP2023/056338, filed on Mar. 13, 2023.

(30) Foreign Application Priority Data
Mar. 14, 2022 (DE) 20 2022 101 364.0

(51) Int. Cl. H01R 13/506; H01R 13/46; H01R 13/58

(52) U.S. Cl. CPC H01R 13/506; H01R 13/465; H01R 13/582

(57) ABSTRACT

A plug connector with a housing that has at least one conductor insertion opening for inserting an electrical conductor from a conductor insertion direction, a conductor clamping device is accommodated in the housing, and at least one housing exterior wall of the housing is designed to have a snap-on contour for snapping onto a holding element. A first receiving groove has a holding portion which is suitable for receiving a holder of the holding element. The housing exterior wall has a second receiving groove with a longitudinal extent greater than a transverse extent. The second receiving groove is suitable for receiving a latch of the holding element. The second receiving groove has counter-latch which interact with the latch of the holding element, and the longitudinal extent of the first receiving groove and the longitudinal extent of the second receiving groove are substantially parallel.

This nonprovisional application is a continuation of International Application No. PCT/EP2023/056338, which was filed on Mar. 13, 2023, and which claims priority to German Patent Application No. 20 2022 101 364.0, which was filed in Germany on Mar. 14, 2022, and which are both herein incorporated by reference.

### BACKGROUND OF THE INVENTION

### Field of the Invention

The invention relates to a plug connector with a housing, wherein the housing has at least one conductor entry opening for inserting an electrical conductor from a conductor insertion direction, and a conductor clamping device is seated in the housing. A housing exterior wall of the housing is designed with a snap-on contour for snapping on a holding element.

### Description of the Background Art

DE 20 2017 107 144 U1, which is incorporated herein by reference, and which shows a plug connector with a holding element, preferably a plate-like holding element, that can snap onto the plug connector. The holding element has two rows of latching elements that are arranged offset from one another and have latching projections. The latching elements drop into latching recesses on the housing of the plug connector, wherein the holding element initially moves in a perpendicular direction toward the latching surface of the plug connector. As soon as the latching elements have dropped into the latching recesses, a transverse displacement of the holding element occurs with respect to the plug connector.

### SUMMARY OF THE INVENTION

It is therefore an object of the invention to provide a plug connector that is further improved as much as possible, with a snap-on contour and with an improved holding element with functionality that is expanded as much as possible, as well as an improved holding element.

In an example, a plug connector with a housing is provided, wherein the housing has at least one conductor entry opening for inserting an electrical conductor from a conductor insertion direction, and wherein a conductor clamping device is seated in the housing. A housing exterior wall of the housing is designed with a snap-on contour for snapping on a holding element. It is proposed according to the invention that the housing exterior wall has a first seating groove with a longitudinal extent greater than a transverse extent, wherein the first seating groove has a holding section that is suitable for seating a holder of the holding element. The housing exterior wall has a second seating groove with a longitudinal extent greater than a transverse extent, wherein the second seating groove is suitable for seating a latch of the holding element. The second seating groove has mating latch that cooperate with the latch of the holding element. The longitudinal extent of the first seating groove and the longitudinal extent of the second seating groove are designed to be substantially parallel.

The holding element can, via the holding section of the first seating groove, be secured against a pulling-off of the holding element from the plug connector perpendicular to the housing wall with the snap-on contour. Owing to the cooperation of the latching elements of the holding element and the mating latching elements of the second seating groove, the holding element is advantageously secured against an unlatching or pulling-off of the holding element from the plug connector in the plane of the housing wall with the snap-on contour. A functional separation for the different holding directions can advantageously take place in a simple manner as a result of the fact that, according to an advantageous improvement, the holding section with the seated holder and the mating latch with the cooperating latch of the holding element are arranged in first and second seating grooves that are distinct or separate from one another. The latch and mating latch advantageously ensure a defined stop for a final position of the holding element and advantageously offer haptic feedback to the user that the final position has been reached. Furthermore, the arrangement according to an advantageous improvement makes possible universal assembly of the holding element on the plug connector. With a standardized design of the holding sections, holders, and latching and mating latching contours, the holding element advantageously can be installed universally on diverse plug connectors. Alternatively, the holding element can be installed on other connection terminals instead of a plug connector. The first and second seating grooves each advantageously have a longitudinal extent that is defined in that the longitudinal extent is greater than a dimension transverse thereto, in particular perpendicular thereto. The longitudinal extent advantageously extends in the plug-in direction and/or in a direction of entry of the electrical conductors into the plug connector. Orientations that are transverse or perpendicular hereto, or at an arbitrary angle hereto, are also possible, however.

The first seating groove and the second seating groove can be designed as a common seating groove. Consequently, it is advantageously made possible that the holder of the holding element and that the latch of the holding element can be seated in a common seating groove. For an advantageous, simplified assembly, the holder of the seating groove has a preferably continuous slot whose width transverse to the longitudinal extent is equal to or preferably somewhat greater than the width of the latch so that the latch can be passed through the slot of the holder.

A web can be arranged between the first and second seating grooves. The web is part of the housing wall that has the snap-on contour, and is advantageously designed to be elastic, at least in sections. An interlocking seating of the holder and/or of the latch in the seating grooves is formed as a result. The holder and/or the latch can therefore be brought into interlocking contact with the side edges of the seating groove, and/or of the holding section, transverse to the longitudinal extent. If the web is elastically deflected, then an at least slight frictional contact of the latch and/or of the holder is also formed transverse to the longitudinal extent.

The holding section of the first seating groove can be arranged ahead of or behind a seating section of the first seating groove in the direction of the longitudinal extent. According to an advantageous improvement, the holder of the holding element can be placed in the seating groove ahead of or behind the holding section in the direction of longitudinal extent, perpendicular to the plane of the housing wall having the snap-on contour. The holder is then displaceable in the direction of the longitudinal extent of the seating groove in such a manner that the holder of the holding element enters into interlocking and/or frictional engagement with the holding section of the seating groove.

The holding section of the first seating groove can be arranged between two end seating sections of the first seating groove. As a result, the holder of the holding element advantageously can be placed in the first seating groove at two different positions, and therefore is displaceable from two mutually opposite directions into the holding section of the first seating groove. Consequently, an advantageous, preferred installation position can be realized depending on installation conditions or for automated assembly.

The seating section can be wider in transverse extent than the holding section in transverse extent. As a result, the holder advantageously can be readily placed in the first seating groove and, after the subsequent displacement, forms an interlocking retention or seating with the holding section of the first seating groove so that an unlatching of the holding element perpendicular to the plane of the housing exterior wall having the snap-on contour is prevented effectively.

The holding section can have a dovetailed or T-slot-shaped cross-sectional contour. With this example, an especially effective interlocking connection of the holding element on the housing or on the housing exterior wall having the snap-on contour is advantageously ensured.

The aforementioned object can also be attained by a holding element with a support contour, suitable for attachment to a snap-on contour of a plug connector, wherein at least a first and a second latch project from the support contour of the holding element. The invention is also characterized in that a holder can project from the support contour of the holding element, which holder can be arranged on the support contour between the first and second latch at a longitudinal direction determined by the first and the second latch. The holder can therefore be an element that is separate from the first and second latch and that projects from the support contour. The holder and the first and the second latch can project in the same direction from the support contour or extend from the support contour in the same direction. An advantageous division of the functions of holding and latching is made possible by the formation of the first and the second latch distinct from the holding element. As a result of the fact that the holder is arranged on the support contour between the first and second latch in the longitudinal direction determined by the first and the second latch, the holder can be arranged on the support contour spatially distant from the first and the second latch. The holding element is advantageously designed to absorb elastic deformations of the holding element arising during the assembly of the holding element on the snap-on contour of the housing.

The holder can be arranged on the support contour distant from the latch, transverse to the longitudinal direction determined by the first and second latch. The first and the second latch advantageously are not arranged in a line with the holder, but rather offset thereto. This advantageously makes it possible that the holder can be seated in a first seating groove on the snap-on contour, and the first and the second latch can be seated in a second seating groove that is distinct from the first seating groove.

More than one and/or more than two holders can project from the support contour. As a result, a holder is formed, in particular for multipole plug connectors, that has multiple holding sections and thus ensures an especially secure and stable attachment of the holding element to the plug connector or to the housing wall of the plug connector.

The holding element can be designed as a latching element and/or as a strain relief element and/or as a label carrier. The design of the holding element as a latching element offers the advantageous attachment of the plug connector to an attachment surface or base. With the design of the holding element as a strain relief element, the electrical lines can be attached to the strain relief element in a strain-relieved manner in a simple way, for example with a cable tie. A design of the holding element as a labeling element is also possible in a simple way so that the plug connector or individual lines can be labeled. It is also possible for the holding element to have multiple functions or design implementations at the same time, for example the holding element can be designed as a strain relief element and at the same time also have elements for labeling, thus be designed as a label carrier. If the plug connector has multiple first and second seating grooves, multiple holding elements can be fixed to the plug connector, wherein the holding elements can either be designed identically, e.g., two or more strain relief elements, or the holding elements can be designed differently. Thus, for example, one or more holding elements designed as a latching element can be combined with one or more holding elements designed as a strain relief element and/or a labeling element.

The aforementioned object is also attained by a set comprising a plug connector with a housing and a holding element with a support contour, wherein the housing has at least one conductor entry opening for inserting an electrical conductor from a conductor insertion direction, and a conductor clamping device is seated in the housing, and a housing exterior wall of the housing is designed with a snap-on contour for snapping on the holding element, wherein, in the assembled state of the holding element on the plug connector, the support contour of the holding element rests against the snap-on contour of the plug connector, wherein at least a first and a second latch project from the support contour of the holding element. Provision is made that at least one holder projects from the support contour of the holding element, which holder is arranged on the support contour between the first and second latch at a longitudinal direction determined by the first and the second latch, the snap-on contour of the plug connector has a first seating groove with a longitudinal extent greater than a transverse extent, wherein the first seating groove has a holding section that, in the assembled state of the holding element on the plug connector, cooperates with a holder of the holding element, and the snap-on contour of the plug connector has a second seating groove with a longitudinal extent greater than a transverse extent, wherein, in the assembled state of the holding element on the plug connector, a latch of the holding element is seated in the second seating groove in a latching manner, and wherein the second seating groove has a complementary mating latch that cooperates with the latch of the holding element.

Owing to the holding section of the first seating groove, the holding element is secured against a pulling-off of the holding element from the plug connector perpendicular to the housing wall with the snap-on contour. Owing to the cooperation of the latching elements of the holding element and the mating latching elements of the second seating groove, the holding element is secured against an unlatching or pulling-off of the holding element from the plug connector in the plane of the housing wall with the snap-on contour. A functional separation for the different holding directions of the holding element on the plug connector for the set comprising plug connector and holding element can advantageously take place in a simple manner as a result of the fact that the holding section with the seated holder and the mating latch with the cooperating latch of the holding element are arranged in first and second seating grooves that are distinct or separate from one another. The latch and mating latch ensure a defined stop for a final position of the holding element and offer haptic feedback to the user that the final position has been reached. The first and second seating grooves each have a longitudinal extent that is defined in that the longitudinal extent is greater than a dimension transverse thereto, in particular perpendicular thereto. The longitudinal extent can advantageously extend in the plug-in direction and/or in a direction of entry of the electrical conductors into the plug connector. Orientations that are transverse or perpendicular hereto, or at an arbitrary angle hereto, are also possible, however.

Two latches of the holding element that act in mutually opposite directions with a complementary mating latch(s) of the seating groove can be seated in the second seating groove in a latching manner. The latch of the holding element and mating latch of the seating groove form two stops in this case that are spaced apart from one another and act in mutually opposite directions. In particular, the stops act in the direction of the longitudinal extent of the seating groove. With this example, the holding element can advantageously be fixed to the plug connector with action in mutually opposite directions. Especially preferably, this fixing is accomplished without play so that the holding element is secured against shifting or displacement on the plug connector.

The aforementioned object is also attained by a plug connector with a housing, wherein the housing can have at least one conductor entry opening for inserting an electrical conductor from a conductor insertion direction, and a conductor clamping device is seated in the housing, and a housing exterior wall of the housing is designed with a snap-on contour for snapping on a holding element. Provision is made that the housing exterior wall has a seating groove with a longitudinal extent greater than a transverse extent, wherein the seating groove has a holding section that is suitable for seating a holder of the holding element, wherein the seating groove is suitable for seating a latch of the holding element, and the seating groove has a complementary mating latch that cooperates with the latch of the holding element.

Only one seating groove can be provided for seating the holder and the latch of the holding element, wherein this one seating groove has a holding section for seating the holder of the holding element as well as mating latch for cooperating with the latch of the holding element. Consequently, the snap-on contour on the housing wall of the plug connector can be made narrow. This example is thus especially advantageous for narrow-construction plug connectors or plug connectors with a small pole count. The holding element and the one or more latch are arranged on the holding element one behind the other or in a straight line in the longitudinal extent in this case.

Two latches of the holding element that act in mutually opposite directions with complementary mating latch of the seating groove can be seated in the seating groove in a latching manner. The latch of the holding element and mating latch of the seating groove form two stops in this case that are spaced apart from one another and act in mutually opposite directions. In particular, the stops act in the direction of the longitudinal extent of the seating groove. With this example, the holding element can advantageously be fixed to the plug connector with action in mutually opposite directions. Especially preferably, this fixing is accomplished at least approximately without play so that the holding element is secured against shifting or displacement on the plug connector.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a plug connector according to an example, in a three dimensional view,

FIG. 2 shows a holding element in an example, in a three dimensional view,

FIG. 3 shows a set comprising plug connector and holding element in an example, in a three dimensional view,

FIG. 4 shows a top view of the snap-on surface of a plug connector of a set comprising plug connector and holding element,

FIG. 5a shows a sectional side view of a set comprising plug connector and holding element,

FIG. 5b shows a sectional view corresponding to the section line A-A in FIG. 5a,

FIG. 6 shows a perspective partial sectional view of a first seating groove and a second seating groove with installed holding element corresponding to the section line A-A in FIG. 5a,

FIG. 7 shows a sectional view corresponding to the section line B-B in FIG. 5a,

FIG. 8a shows a sectional side view of a set comprising plug connector and holding element in a first preassembly position,

FIG. 8b shows a sectional view corresponding to the section line C-C from FIG. 8a,

FIG. 9a shows a sectional side view of a set comprising plug connector and holding element in a second preassembly position,

FIG. 9b shows a sectional view corresponding to the section line D-D from FIG. 9a,

FIG. 10 shows a holding element in an example,

FIG. 11 shows a holding element in an example,

FIG. 12 shows a holding element in an example,

FIG. 13 shows a holding element in an example.

### DETAILED DESCRIPTION

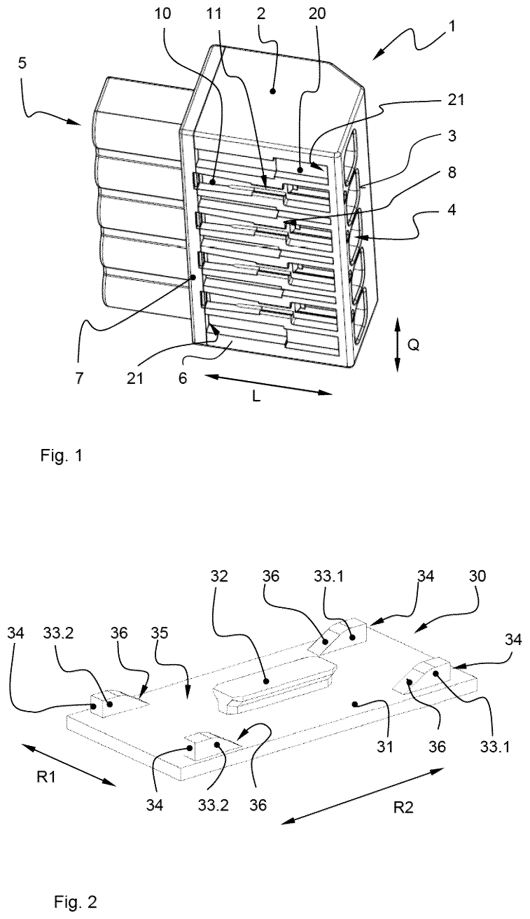

FIG. 1 shows a plug connector 1 in an example with a housing 2 that has, on a first housing exterior wall 3, conductor entry openings 4 for inserting electrical conductors. Provided in the housing 2 of the plug connector 1 are contact inserts with conductor clamping devices, for example spring-loaded terminals, for clamping the electrical conductors. The contact inserts have plug-in contacts, e.g., pin contacts and/or socket contacts. The plug connector 1 has, on a side different from the first housing exterior wall 3, a plug-in contour 5, with the aid of which the plug connector 1 can be connected to a mating connector so that the plug-in contacts of the plug connector 1 can be electrically connected to mating plug-in contacts of the mating connector.

A snap-on contour 7 is formed on an additional housing exterior wall 6 of the housing 2 that is different from the first housing exterior wall 3. For this purpose, the housing wall 6 has at least a first seating groove 10 and a second seating groove 20. The first seating groove 10 and the second seating groove 20 in this case form a recess in the housing wall 6, and each have a longitudinal extent L and a transverse extent Q. The respective longitudinal extent L is greater than the respective transverse extent Q. In the example shown, multiple first seating grooves 10 and second seating grooves 20 are present, the number of which can be determined by the size of the housing wall 6. In the example shown, there are a total of four first seating grooves 10 and five second seating grooves 20, wherein the first seating grooves 10 and second seating grooves 20 are arranged in alternation. In each case, a web 8 remains in the housing wall 6 between the seating grooves 10, 20.

A holding element 30, such as is shown in FIG. 2, for example, can be attached to the snap-on contour 7. For this purpose, the first seating grooves each have a holding section 11, at which a holder 32 of the holding element 30 can be seated. The second seating grooves 20 each have mating latch 21 that can cooperate with latch 33 of the holding element 30.

FIG. 2 illustrates an exemplary holding element 30. The holding element 30 has a preferably flat and plate-like base element 31, wherein a holder 32 that projects from a support contour 35 is arranged on the base element 31. As can be seen, the holder 32 has an oblong and approximately T-shaped contour. Also visible on the base element 31 are multiple first latch 33.1 and second latch 33.2, which are arranged on the same side of the base element 31 as the holder 32. The holder 32 in this case is arranged on the support contour 35 between the first and second latch 33.1, 33.2 in a first direction of extent R1 determined by the first latch 33.1 and the second latch 33.2. The oblong contour of the holder 32 extends essentially parallel to the first direction of extent R1. In addition, the holder 32 is arranged spaced apart from the latch 33.1, 33.2, transverse to a direction of extent R1 determined by the first and second latch 33.1, 33.2. In other words, the holder 32 is arranged offset to an imaginary connecting line through the first and second latch 33.1, 33.2. Accordingly, the holder 32 is arranged between the latch 33.1, 33.2 in the second direction of extent R2 oriented transverse to the first direction of extent. The holder 32 is therefore preferably arranged centered on the base element 31. In this design, the first and the second latch 33.1, 33.2 in each case form a pair of latch with latching surfaces 34 that point away from each other. In addition, the first and second latch 33.1, 33.2 each have stop bevels 36. The stop bevels 36 of a first latch 33.1 and of a second latch 33.2 in this case are directed toward one another. The wedge-shaped stop bevels 36 of the first latch 33.1 and of the second latch 33.2 in this case run obliquely toward the outer mutually opposing edge regions of the holding element 30, starting from the snap-on surface 35 of the holding element 30.

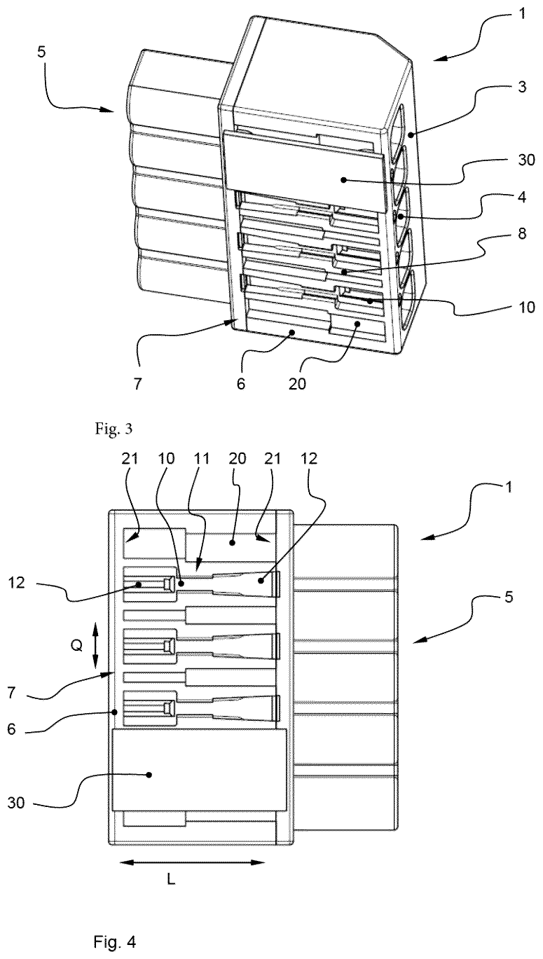

FIG. 3 shows a set comprising a plug connector 1 with a holding element 30 attached to the snap-on contour 7. It can be seen here that not all first and second seating grooves 10, 20 are covered or used by the holding element 30. Consequently, an additional holding element 30, for example, can advantageously be attached to the snap-on contour 7 using the remaining free seating grooves 10, 20. Alternatively, the illustrated holding element 30 can advantageously be positioned or attached to another, freely selectable position of the snap-on contour 7.

In FIG. 4, the first seating grooves and second seating grooves 20 arranged in alternation on the housing wall 6 can again be seen. It is clearly visible that the first seating groove 10 has a holding section 11 that is adjoined on each of its two sides by a seating section 12. The seating section 12 is wider or greater in the transverse extent than the passage for the holding section 11. The holding section 11 is therefore arranged between preferably end seating sections 12. Consequently, the holding element 30 advantageously can be inserted easily into the seating section 12.

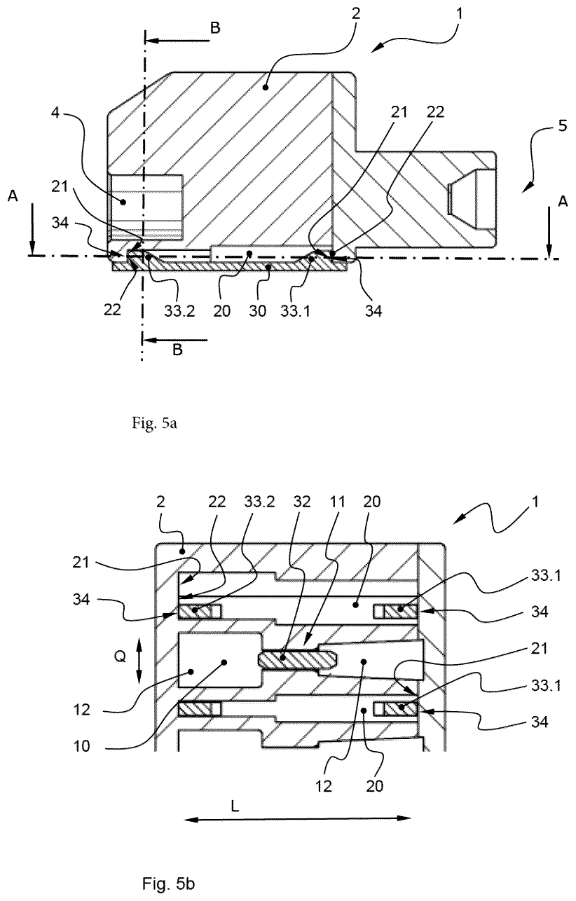

FIG. 5a shows a cross-sectional view through the set comprising plug connector 1 and holding element 30 in a final assembly position of the holding element 30 on the plug connector 1, wherein the section plane runs along the second seating groove 20. It can be seen that the first and second latch 33.1, 33.2 are each latched with the mating latch 21 of the second seating groove 20. In this case, the respective stop faces 34 of the first and second latch 33.1, 33.2 face respective stop faces 22 of the mating latch 21. Preferably, the stop faces 34 of the latch 33.1, 33.2 rest against the stop faces 22 of the mating latch 21 at least nearly free of play in this case. In this way, a rattle-free attachment of the holding element 30 to the plug connector can advantageously be realized.

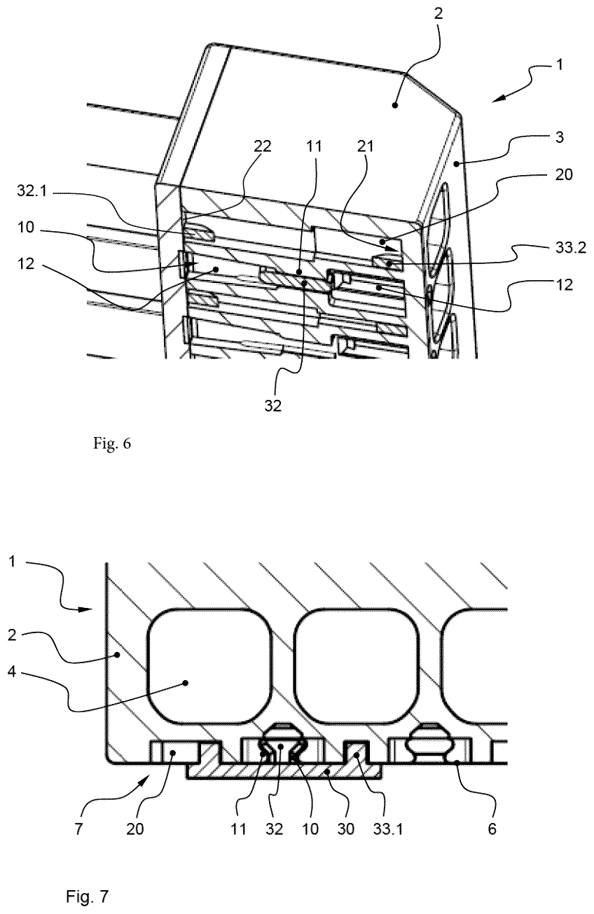

This is illustrated again in FIG. 5b, which shows a sectional view passing through the first and second seating grooves corresponding to the section line A-A in FIG. 5a. Also evident is the holder 32 of the holding element 30, which is arranged in the holding section 11 of the first seating groove 10. Also clearly visible are the two seating sections 12 that adjoin the holding section 11 on both sides and are widened in the transverse direction Q in comparison with the holding section 11. This arrangement is illustrated again in FIG. 6 with the three-dimensional sectional view of the depiction from FIG. 5b.

FIG. 7 shows a sectional view perpendicular to the longitudinal extent L corresponding to the section line B-B in FIG. 5a. Evident in particular is the dovetailed cross-sectional shape of the holder 32, which is arranged in a complementary-shaped holding section 11 of the first seating groove 10. As a result, the holding element 30 is held on the snap-on contour 7 formed on the additional housing wall 6 and secured against a pulling-off perpendicular to the additional housing wall 6.

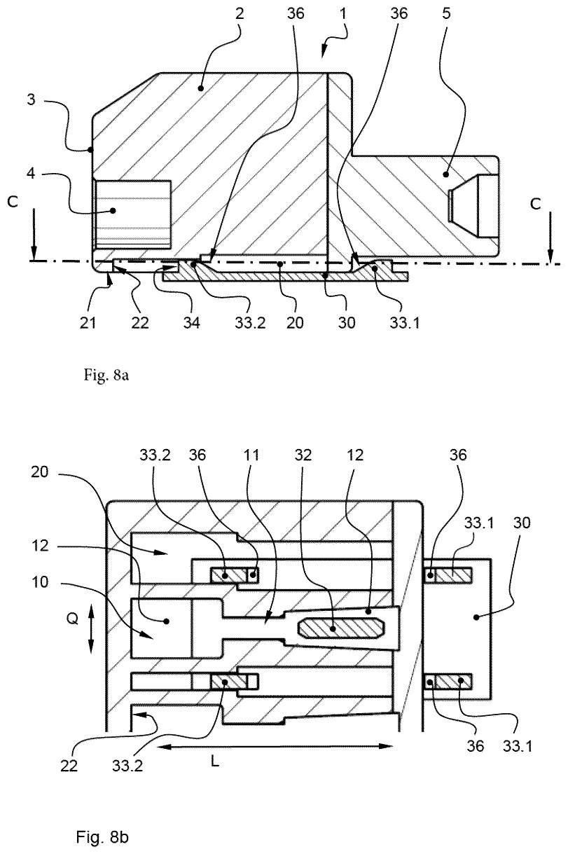

FIGS. 8a and 8b show the plug connector 1 with a holding element 30 in a first preassembly position. In this first preassembly position, the holding element 30 is placed on the snap-on surface 7 of the plug connector in a position offset in the direction of the plug-in contour 5. The holder 32 is fitted into a holding section 11 of the first seating groove 10 that abuts the holding section 11 in the direction of the plug-in contour 5. The first latch 33.1 are located in a first preassembly position outside the respective, associated second seating groove 20. The second latch 33.2, in contrast, have already dropped into the respective second seating groove 20. It is evident that the bottom second latch in the depiction in FIG. 8b rests against or is guided on side walls of the second seating groove 20 on both sides in the transverse direction Q. The top second latch 33.2 in the view in FIG. 8b, in contrast, is guided only on the side wall of the second seating groove 20, which faces the first seating groove 10 in which the holder 32 is seated. The holding element 30 is thus already pre-positioned in the preassembly position in the transverse direction Q in such a manner that the holder 32 of the holding element 30 and the seating section 12 of the first seating groove 10 are aligned with one another in the longitudinal direction L.

To convey the holding element 30 to the final assembly position from the preassembly position, the holding element 30 is displaced on the snap-on contour 7 along the additional housing wall 6 in the direction of the first housing wall 3 with the conductor insertion openings 4. During the displacement motion, the holder 32 engages in an interlocking and/or possibly frictional manner with the seating section 12 of the first seating groove 10. During the displacement motion of the holding element 30, the stop bevels 36 of the first latch 33.1 slide up over a housing contour of the housing 2 of the plug connector so that the holding element 30 is elastically deflected in the section between the holder 32 and the first latch 33.1. The holding element 30 is deflected away from the housing 2 of the plug connector in this process. The displacement motion takes place until the stop face 34 of the second latch 33.2 comes into contact with the stop face 22 of the mating latch 21 of the second seating groove 20. In this final assembly position, for example according to FIG. 5b, the first latch 33.1 has slid past the housing contour of the housing 2 and clicks into the second seating groove 20 via the elastic restoring force of the holding element 30 so that the stop face 34 of the first latch 33.1 faces the stop face 22 of the mating latch 21. The clicking of the first latch 33.1 into the second seating groove 20 preferably gives the user haptic and audible feedback that the holding element 30 is correctly located in the final assembly position.

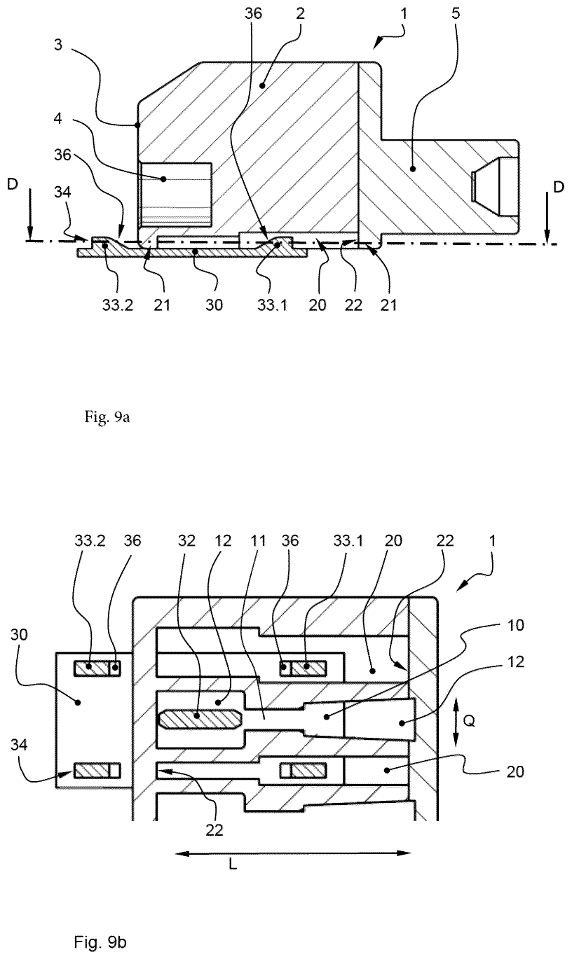

In FIGS. 9a and 9b, the plug connector 1 and the holding element 30 are located in a second preassembly position that differs from the first preassembly position. The first and the second preassembly positions differ in that the holding element 30 in the second preassembly position is placed on the snap-on surface 7 of the plug connector 1 in a position offset in a direction facing away from the direction of the plug-in contour 5. The holding element 30 projects past the first housing wall 3 relative to the housing 2 in this case. The holder 32 of the holding element 30 is placed in a seating section 12 of the first seating groove 10 abutting the holding section 11 that is arranged on a side of the holding section 11 facing away from the plug-in contour 5 in this case.

The conveying from the second preassembly position to the final assembly position takes place in a manner corresponding to the conveying from the first preassembly position to the final assembly position, with the sole difference that the direction of displacement now takes place in the direction of the plug-in contour 5. Consequently, reference is made here to the corresponding description of FIGS. 8a and 8b. A freely selectable assembly direction is made possible in this way.

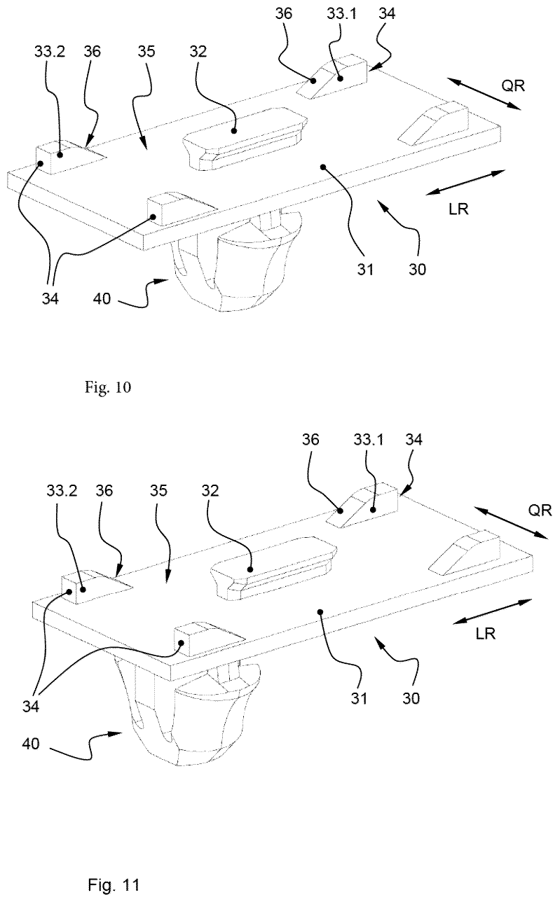

FIGS. 10 to 13 show different examples of a holding element 30 in the implementation of a mounting plate with one or more latching pegs 40. The latching peg or pegs 40 in this case are arranged on a surface of the base plate 31 of the holding element 30 facing away from the latching surface 35 on which the first and second latch 33.1, 33.2 are arranged. The latching pegs 40 serve to attach the holding element 30, and thus the plug connector 1, to a mounting plate or the like.

The example in FIG. 10 shows a holding element 30 with one latching peg 40, which is arranged centered in a longitudinal direction LR and a transverse direction QR of the holding element 30.

The example in FIG. 11 shows a holding element 30 with one latching peg 40, which is arranged off-center in the longitudinal direction LR of the holding element 30 and centered in the transverse direction QR of the holding element 30. The different attachment of the latching peg 40 to the holding element 30 ensures the attachment of the holding element 30 to a base in different installation situations.

The example in FIG. 12 shows a holding element 30 with two latching pegs 40, which are arranged centered in the longitudinal direction LR of the holding element 30. In the transverse direction QR of the holding element 30, the latching pegs are arranged one after the other or side by side in a line. In addition, two holder 32 arranged side by side in the transverse direction QR of the holding element 30 are provided on the latching surface 35 of the holding element 30, which in this example are each arranged opposite the latching pegs 40 arranged on the side facing away from the latching surface 35. This is not strictly necessary, however. Moreover, three first latch 33.1 and three second latch 33.2 each are provided in this example. The number of holders 32 can be variable, and can also be more than two depending on the size of the holding element 30 in the transverse direction QR. Accordingly, the number of first and second latch 33.1, 33.2 can also be more than three. In this way, the holding element 30 can be tailored to the width of the plug connector 1 or be chosen from an appropriately stocked selection of holding elements 30. Corresponding plug connectors 1 with a greater width can then also have multiple first seating grooves 10 and a multiplicity of second seating grooves 20 in order to accommodate the appropriate number of holders 32 and first and second latch 33.1, 33.2. In addition, with an appropriate width of the plug connector in the transverse extent Q, two or more holding elements 30 can also be attached to the snap-on contour of the plug connector 1. Owing to the arrangement of two or more latching pegs 40 on the holding element 30, the holding forces of the holding element on a base are increased, on the one hand, and on the other hand a twisting of the holding element on the base is prevented.

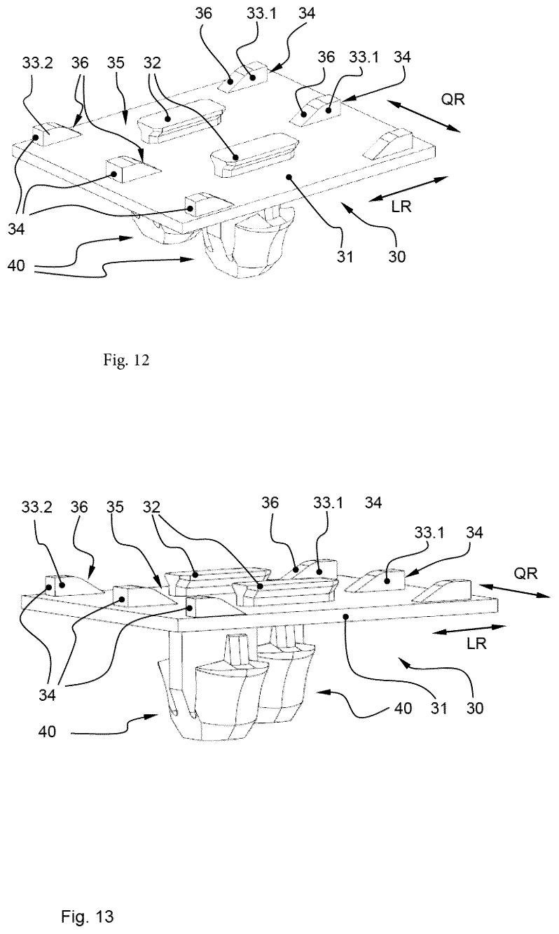

The example in FIG. 13 of the holding element 30 differs from the example according to FIG. 12 in that the latching pegs 40 are not arranged one after the other in a line in the transverse direction QR, but instead offset from one another on the holding element 30.

As an example to the implementation as a mounting plate, the holding element 30 can be designed as a strain relief element. In this case, the base plate 31 of the holding element 30 is elongated in such a manner that it projects beyond the first housing side 3 of the housing 2 of the plug connector 1 in the final assembly position, and has appropriate fasteners, for example through holes for a cable tie. Alternatively, the design of the holding element 30 as a mounting plate could also be combinable with the design as a strain relief element.

The holding element 30 can also be designed as an identification element. In this case, the base plate 31 of the holding element 30 is again elongated in such a manner that it projects beyond, e.g., the first housing side 3 of the housing 2 of the plug connector 1 in the final assembly position, and accordingly provides a surface for an inscription or other identification. The inscription area could also project, e.g., laterally beyond the housing 2 of the plug connector, however.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A plug connector comprising:
a housing that comprises at least one conductor entry opening to insert an electrical conductor from a conductor insertion direction;
a conductor clamping device arranged in the housing; and
at least one housing exterior wall of the housing having a snap-on contour to snap on a holding element,
wherein the housing exterior wall has a first seating groove with a longitudinal extent greater than a transverse extent, the first seating groove having a holding section to seat a holder of the holding element,
wherein the housing exterior wall has a second seating groove with a longitudinal extent greater than a transverse extent, the second seating groove seating a latch of the holding element,
wherein the second seating groove has mating latch that cooperates with the latch of the holding element, and
wherein the longitudinal extent of the first seating groove and the longitudinal extent of the second seating groove are designed substantially parallel.

2. The plug connector according to claim 1, further comprising a web arranged between the first seating groove and the second seating groove.

3. The plug connector according to claim 1, wherein the holding section of the first seating groove is arranged ahead of or behind a seating section of the first seating groove in the direction of the longitudinal extent.

4. The plug connector according to claim 3, wherein the holding section of the first seating groove is arranged between two end seating sections of the first seating groove.

5. The plug connector according to claim 3, wherein the seating section is wider in transverse extent than the holding section in transverse extent.

6. The plug connector according to claim 1, wherein the holding section has a dovetailed or T-slot-shaped cross-sectional contour.

7. A holding element comprising:
a support contour for attachment to a snap-on contour of a plug connector;
at least a first and a second latch that project from the support contour of the holding element; and
at least one holder that projects from the support contour of the holding element, the at least one holder being arranged on the support contour between the first and second latch at a longitudinal direction determined by the first and the second latch.

8. The holding element according to claim 7, wherein the holder is arranged on the support contour at a distance from the latch, transverse to the longitudinal direction determined by the first and second latch.

9. The holding element according to claim 7, wherein more than one holder projects from the support contour.

10. The holding element according to claim 7, wherein the holding element is a latching element or a strain relief element or a label carrier.

11. A set comprising:
a holding element with a support contour;
a plug connector with a housing, the housing having at least one conductor entry opening for inserting an electrical conductor from a conductor insertion direction, a housing exterior wall of the housing having a snap-on contour for snapping on the holding element;
a conductor clamping device arranged in the housing, and
wherein, in an assembled state of the holding element on the plug connector, the support contour of the holding element rests against the snap-on contour of the plug connector,
wherein at least a first and a second latch project from the support contour of the holding element,
wherein at least one holder projects from the support contour of the holding element, the holder being arranged on the support contour between the first and second latch at a longitudinal direction determined by the first and the second latch, wherein the snap-on contour of the plug connector has a first seating groove with a longitudinal extent greater than a transverse extent,
wherein the first seating groove has a holding section that, in the assembled state of the holding element on the plug connector, cooperates with a holder of the holding element, and
wherein the snap-on contour of the plug connector has a second seating groove with a longitudinal extent greater than a transverse extent,
wherein, in the assembled state of the holding element on the plug connector, a latch of the holding element is seated in the second seating groove in a latching manner, and
wherein the second seating groove has a complementary mating latch that cooperates with the latch of the holding element.

12. The set according to claim 11, wherein two latches of the holding element that act in mutually opposite directions with complementary mating latch of the second seating groove are seated in the second seating groove in a latching manner.

13. A plug connector comprising:
a housing that comprises at least one conductor entry opening to insert an electrical conductor from a conductor insertion direction;
a conductor clamping device arranged in the housing; and
a housing exterior wall of the housing having a snap-on contour to snap on a holding element,
wherein the housing exterior wall has a seating groove with a longitudinal extent greater than a transverse extent, the seating groove having a holding section to seat a holder of the holding element,
wherein the seating groove seats a latch of the holding element, and
wherein the seating groove has a complementary mating latch that cooperates with the latch of the holding element.

14. The plug connector according to claim 13, wherein two latches of the holding element that act in mutually opposite directions with complementary mating latch of the seating groove are seated in the seating groove in a latching manner.
